(19) United States
(12) Patent Application Publication
(10) Pub. No.: US 2022/0284259 A1
(43) Pub. Date: Sep. 8, 2022

(54) COMPUTER AUTOMATED CLASSIFICATION OF NON-STRUCTURED DATA STREAMS

(71) Applicant: International Business Machines Corporation, Armonk, NY (US)

(72) Inventors: Ana Paula Brambila, Sao Paulo (BR); Filipe Avelino Correa, Sao Paulo (BR); Pablo Roberto Millicay Gonzalez, Sao Paulo (BR); Thiago Bianchi, Sao Carlos (BR)

(21) Appl. No.: 17/190,372

(22) Filed: Mar. 2, 2021

(51) Int. Cl. G06N 3/04; G06F 16/906; G06N 3/08; G06F 17/14

(52) U.S. Cl. CPC G06N 3/04; G06F 16/906; G06N 3/08; G06F 17/14

(57) ABSTRACT

Automated classification of non-structure data streams from a plurality of Internet of Things (IoT) devices includes receiving, by a computer, from the plurality of IoT devices a data stream including a set of labeled readings S with a predetermined sample size n and a predetermined partition size m. The received data stream is partitioned into a partition set S′ including m readings. The computer determines a set of features associated with the data stream based on the partition set S′ by applying feature engineering techniques. A vector representation of the obtained set of features is built by the computer to place each feature on a same range scale. A predetermined minimum number of layers and neurons is then selected based on the set of features for training a neural network. Finally, non-structured data streams from new or unknown data sources can be classified using the trained neural network.

### BACKGROUND

The present invention generally relates to the field of artificial intelligence (AI), and more particularly to classification, at a computer, of non-structured data streams from internet-of-things devices.

The internet of things (IoT) is a computing concept that describes the idea of everyday physical objects being connected to the internet and being able to identify themselves to other devices. The term is closely identified with radio frequency identification (RFID) systems as the method of communication, although it may also include other sensor technologies, wireless technologies, or QR codes. IoT devices and sensors are designed to use extremely lightweight protocols for messaging transport such as, for example, Message Queuing Telemetry Transport (MQTT). However, these protocols typically require minimized data packets that do not contain relevant information regarding data sources other than the data itself.

### SUMMARY

The present disclosure recognizes the shortcomings and problems associated with classification of non-structured data streams. Particularly, problems associated with automatic classification of non-structured data streams received, for example, from IoT devices, without data categorization before processing, and the provision of information regarding data source(s) to users. Therefore, there is a need for a method and system for automatically classifying, by a computer, non-structured data streams from unknown sources according to a measurement type and historically classified data streams.

Shortcomings of the prior art are overcome and additional advantages are provided through the provision of a computer-implemented method for classifying non-structure data streams from IoT devices. The method includes receiving, by one or more processors, from a plurality of Internet of Things (IoT) devices a data stream comprising a set of labeled readings S with a predetermined sample size n and a predetermined partition size m, in response to receiving the data stream, partitioning the received data stream into a partition set S′ including m readings, determining, a set of features associated with the data stream by applying feature engineering techniques to the partition set S′, processing the set of features using concatenation and normalization to build a vector representation of the set of features to place each feature on a same range scale, training a neural network using a topology of a predetermined minimum number of layers and neurons selected based on the set of features, and classifying non-structured data streams from new or unknown sources using the trained neural network.

Another embodiment of the present disclosure provides a computer program product for classifying non-structure data streams from IoT devices, based on the method described above.

Another embodiment of the present disclosure provides a computer system for classifying non-structure data streams from IoT devices, based on the method described above.

### BRIEF DESCRIPTION OF THE DRAWINGS

The following detailed description, given by way of example and not intended to limit the invention solely thereto, will best be appreciated in conjunction with the accompanying drawings, in which:

FIG. 1 is a block diagram illustrating a networked computer environment, according to an embodiment of the present disclosure;

FIG. 2 depicts a computer system for automatically classifying non-structured data streams from IoT devices, according to an embodiment of the present disclosure;

FIG. 3 depicts a flowchart illustrating the steps of a computer-implemented method for classifying non-structured data streams from IoT devices, according to an embodiment of the present disclosure;

FIG. 4 is a block diagram of internal and external components of a computer system, according to an embodiment of the present disclosure;

FIG. 5 is a block diagram of an illustrative cloud computing environment, according to an embodiment of the present disclosure; and

FIG. 6 is a block diagram of functional layers of the illustrative cloud computing environment of FIG. 5, according to an embodiment of the present disclosure.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

As mentioned above, IoT devices and sensors are designed to use extremely lightweight protocols for messaging transport that require minimized data packets. Typically, these minimized data packets lack relevant information regarding data sources, including only the data measurements. Accordingly, embodiments of the present disclosure, propose the addition of an automated classification module based on feature engineering techniques that may prevent the need for exploring and categorizing a data stream before processing it. By doing this, dynamic dashboards can be built by simply connecting to a new source of data that can be automatically labeled (e.g., temperature, motion, CO₂, etc.) based on historical data already stored in the platform.

Therefore, embodiments of the present invention provide a method, system, and computer program product for computer automated classification of non-structure data streams from IoT devices. The following described exemplary embodiments provide a system, method, and computer program product to, among other things, implement a feature engineering technique that summarizes data streams and allows the application of a neural network model with a minimum number of neurons and layers for classifying non-structured data streams from IoT devices (i.e., raw, unstructured data without associated metadata). Further, the present embodiments provide an adaptable approach that allows implementing feature engineering techniques, such as histograms and Fourier Transform, for training a neural network.

Thus, the present embodiments have the capacity to improve the technical field of artificial intelligence by classifying non-structured IoT data streams from unknown sources according to a measurement type (e.g., pressure, temperature, or any other type of sensor measurements) and historically classified data streams by using feature engineering and machine learning techniques. The present embodiments, allow users of IoT platforms to accelerate the process of receiving insights from new data sources and the construction of dynamic dashboards. Further, the present embodiments can be used across different IoT platforms and/or software including, for example, IBM's Watson IoT Platform, IBM's IoT software such as Maximo Asset Performance Management and Tririga Building Insights.

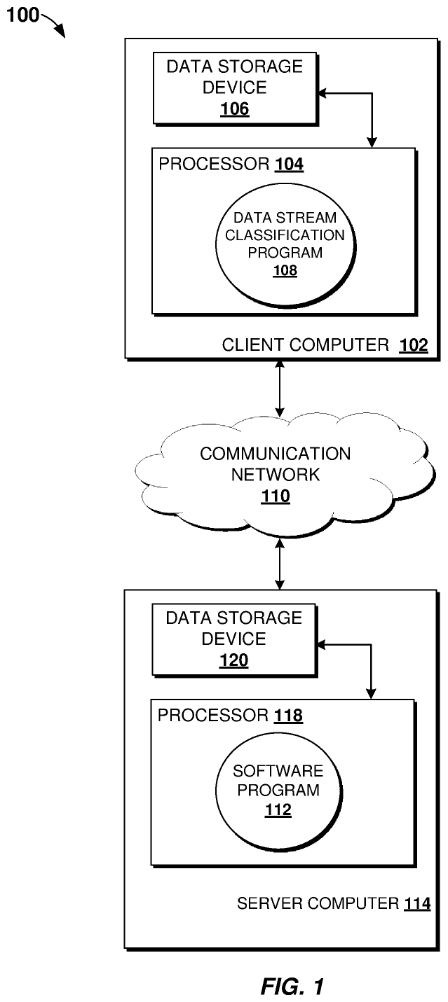

Referring now to FIG. 1, an exemplary networked computer environment 100 is depicted, according to an embodiment of the present disclosure. FIG. 1 provides only an illustration of one embodiment and does not imply any limitations with regard to the environments in which different embodiments may be implemented. Many modifications to the depicted environment may be made by those skilled in the art without departing from the scope of the invention, as recited by the claims.

The networked computer environment 100 may include a client computer 102 and a communication network 110. The client computer 102 may include a processor 104, that is enabled to run a data stream classification program 108, and a data storage device 106. Client computer 102 may be, for example, a mobile device, a telephone (including smartphones), a personal digital assistant, a netbook, a laptop computer, a tablet computer, a desktop computer, or any type of computing devices capable of accessing a network.

The networked computer environment 100 may also include a server computer 114 with a processor 118, that is enabled to run a software program 112, and a data storage device 120. In some embodiments, server computer 114 may be a resource management server, a web server, an IoT device/sensor, or any other electronic device capable of receiving and sending data via the communication network 110. In another embodiment, server computer 114 may represent a server computing system utilizing multiple computers as a server system, such as in a cloud computing environment.

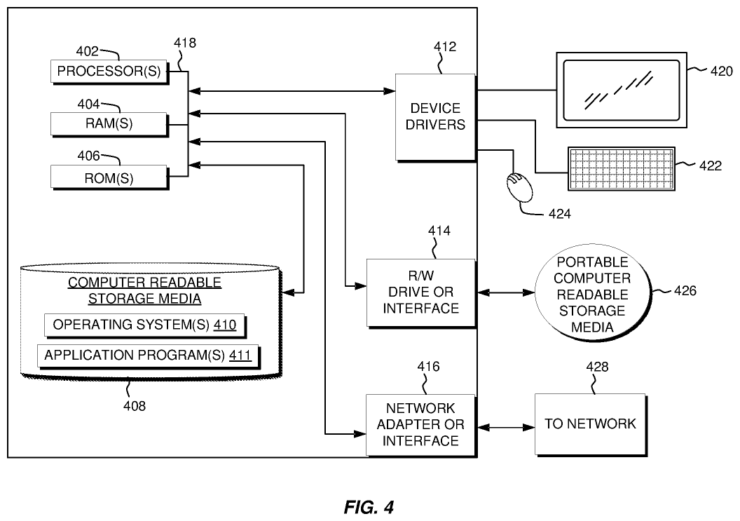

The data stream classification program 108 running on client computer 102 may communicate with the software program 112 running on server computer 114 via the communication network 110. As will be discussed with reference to FIG. 4, client computer 102 and server computer 114 may include internal components and external components. In an embodiment, the server computer 114 may include one or more IoT devices and/or sensors capable of transmitting a data stream (e.g., raw/unstructured data) to the client computer 102 to be processed by the data stream classification program 108.

The networked computer environment 100 may include a plurality of client computers 102 and server computers 114, only one of which is shown. The communication network 110 may include various types of communication networks, such as a local area network (LAN), a wide area network (WAN), such as the Internet, the public switched telephone network (PSTN), a cellular or mobile data network (e.g., wireless Internet provided by a third or fourth generation of mobile phone mobile communication), a private branch exchange (PBX), any combination thereof, or any combination of connections and protocols that will support communications between client computer 102 and server computer 114, in accordance with embodiments of the present disclosure. The communication network 110 may include wired, wireless or fiber optic connections. As known by those skilled in the art, the networked computer environment 100 may include additional computing devices, servers or other devices not shown.

Plural instances may be provided for components, operations, or structures described herein as a single instance. Boundaries between various components, operations, and data stores are somewhat arbitrary, and particular operations are illustrated in the context of specific illustrative configurations. Other allocations of functionality are envisioned and may fall within the scope of the present invention. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present invention.

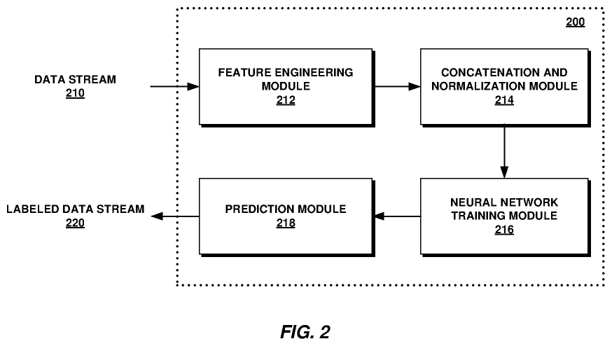

Referring now to FIG. 2, components of a computer system 200 for classifying non-structured data streams from IoT devices are shown, according to an embodiment of the present disclosure. In this embodiment, the computer system 200 includes a feature engineering module 212, a concatenation and normalization module 214, a neural network training module 216, and a prediction module 218. A data stream 210 including raw, non-structured data from a plurality of IoT devices (not shown) can be received and processed by the system 200 to generate a labeled data stream 220, as illustrated in the figure. Specifically, the data stream 210 includes a plurality of measurements corresponding to different types of metrics such as, for example, pressure, temperature, or any other type of measurement performed by the IoT devices.

According to an embodiment, the data stream 210 includes a set of historically classified data streams. Specifically, the data stream 210 includes a set of labeled readings S obtained from the plurality of IoT sensors. In this embodiment, the set of labeled readings S is given by S={(r₁,l₁) . . . , (r₁,lᵢ)}, where r represents the reading value and l represents the label associated with the reading r. A sample size n and a partition size m are predefined for the set of readings S.

Based on the predefined sample size n and partition size m, the feature engineering module 212 determines a partition set S′ given by:

S′={S₁={r₁, . . . , rₙ}, S₂={rₙ₊₁, . . . , r₂ₙ}, . . . , Sⱼ={rₙ₍ⱼ₋₁₎₊₁, . . . , rₙⱼ}, . . . Sₖ={rₙ₍ₖ₋₁₎₊₁, . . . , rₙₖ}}, where

$$k = [ \frac{i}{n} ]$$

It should be noted that when the i−kn readings are lower than n, the readings are not included in S′.

Feature engineering is the process of using domain knowledge (e.g., pre-labeled historic readings) to extract features from raw or non-structured data via data mining techniques. These features can then be used to improve the performance of machine learning algorithms. Accordingly, once the partitioned set S′ is determined, the feature engineering module 212 applies a sequence of feature extraction processes to the partitioned set S′ in the following manner:

1) Measurement Summarization: given a number of readings defined by the partition size m, in which m<n, n mod m=0, for each SₖϵS′ and a factor of sample size n, the feature engineering module 212 computes a measurement that summarizes the m readings in the partition, i.e., a metric that represents the readings. Examples of metrics include mean, standard deviation, mode, and media.

Then, considering as M=m₁, . . . mₛ the s measurement function chose to summarize the m readings in the partition, the measurement summarization process conducted by the feature engineering module 212 maps S′ to a new feature space V, as follows:

V={v₁={m₁(r₁:rₘ), . . . , m₁(rₙ₋ₘ₊₁:rₘ), . . . , mₛ(r₁:rₘ), . . . , mₛ(rₙ₋ₘ₊₁:rₙ)}, v₂={m₁(rₙ₊₁:rₙ₊₁₊ₘ), . . . , m₁(r₂ₙ₋ₘ₊₁:r₂ₙ), . . . , mₛ(rₙ₊₁:rₙ₊₁₊ₘ), . . . mₛ(r₂ₙ₋ₘ₊₁:r₂ₙ)}, . . . , vⱼ={m₁(rₙ₍ⱼ₋₁₎₊₁:rₙ₍ⱼ₋₁₎₊₁₊ₘ), . . . , m₁(rₙⱼ₋ₘ₊₁:rₙⱼ), . . . , mₛ(rₙ₍ⱼ₋₁₎₊₁:rₙ₍ⱼ₋₁₎₊₁₊ₘ), . . . mₛ(rₙⱼ₋ₘ₊₁:rₙⱼ)}, . . . , vₖ={m₁(rₙ₍ₖ₋₁₎₊₁:rₙ₍ₖ₋₁₎₊₁₊ₘ), . . . , m₁(rₙₖ₋ₘ₊₁:rₙₖ), . . . , mₛ(rₙ₍ₖ₋₁₎₊₁:rₙ₍ₖ₋₁₎₊₁₊ₘ), . . . mₛ(rₙₖ₋ₘ₊₁:rₙₖ)}}, in which each vϵV is a vector with

$$\frac{n}{m} \times s$$

components.

2) Histogram: given the number of components

$$\frac{n}{m} \times s$$

of each vϵV, the feature engineering module 212 uses the same number of components to generate a histogram that counts the number of readings within the same range. The histogram, as known in the art, can provide an accurate representation of the distribution of the numerical data. It is an estimate of the probability distribution of a continuous variable. Histograms differ from bar graphs in the sense that a bar graph relates two variables, but a histogram relates only one. Thus, based on the histogram, the feature engineering module 212 infers a probability distribution for the continuous variable r (i.e., the raw sensor readings r) that is defined by:

$$h = \frac{max ( {S}_{k} ) - min ( {S}_{k} )}{\frac{n}{m} \times s} ,$$

where h is the bandwidth of each range.

3) Fourier Transform: given the sample size n (i.e., n readings), the feature engineering module 212 applies a Fourier transform over S′ to obtain sinusoid parameters including amplitude, frequency, and phase, that could generate the n readings. According to an embodiment, the Fourier transform helps characterizing a periodicity of the data in the set of labeled readings S′ (i.e., data stream 210). As known by those skilled in the art, a Fourier Transform is an important processing tool that can be used to decompose a function into an alternate representation, characterized by its sine and cosine components. The output of the transformation represents the function in the Fourier or frequency domain, while the input is the spatial domain equivalent. In the Fourier domain, each data point represents a particular frequency contained in the spatial domain.

With continued reference to FIG. 2, the concatenation and normalization module 214 concatenates and normalizes the features obtained in the measurement summarization, histogram and Fourier transform steps performed by the feature engineering module 212. Accordingly, the concatenation and normalization module 214 uses the obtained features to build a vector representation. The normalization step puts all the obtained features on the same range scale. It should be noted that the normalization step is necessary prior to training the neural network.

Subsequently, the neural network training module 216 uses the following topology to train a neural network:

Input layer: For the input layer, the number of neurons is equal to

$$\frac{n}{m} \times s \times 2$$

(from measurement summarization and histogram) added to the Fourier transform parameters. The number of neurons in the input layer corresponds to the number of components of the vector generated by the previously described concatenation and normalization module 214. Specifically,

$$\frac{n}{m}$$

represents the number of parts in each sample size n. For example, for a sample size n=1000 readings and partition size m=100 readings,

$$\frac{n}{m}$$

equals 10 parts with s being the number of measurements or metrics functions to be applied to each part (e.g., mean, standard deviation, mode, and median). If, for example, mean and standard deviation are chosen as metric functions, s is equal to two. Therefore, the number of features after this process is equal to

$$\frac{n}{m}$$

parts times the number of measurements functions chosen. According to the above example, 10 parts times applied to the 2 measurements functions results in 10 means and 10 standard deviations added by 10 histogram parts.

Hidden layer: For the hidden layer, the number of neurons is chosen arbitrarily; and

Output layer: For the output layer, the number of neurons corresponds to the number of unique labels in S, i.e., the one-hot encoding that represents the types of sensors in the pre-labelled historical readings (e.g., indoor temperature, outdoor temperature, relative humidity, CO₂ level, etc.). Stated differently, the output of the neural network corresponds to the types of sensors to be classified.

After training the neural network, the prediction module 218 uses the trained neural network model to classify the set of n IoT sensor readings. Additionally, in an embodiment, an accuracy of the neural network model can be evaluated and, based on the evaluation, process (e.g., n and m) and neural network parameters can be adjusted in the prediction module 218.

It should be noted that data collection (e.g., from IoT devices/sensors) is done with user consent via, for example, an opt-in and opt-out feature. Additionally, user(s) can choose to stop having his/her information being collected or used. In some embodiments, user(s) can be notified each time data is being collected. The collected data is envisioned to be secured and not shared with anyone without previous consent. User(s) can stop data collection at any time.

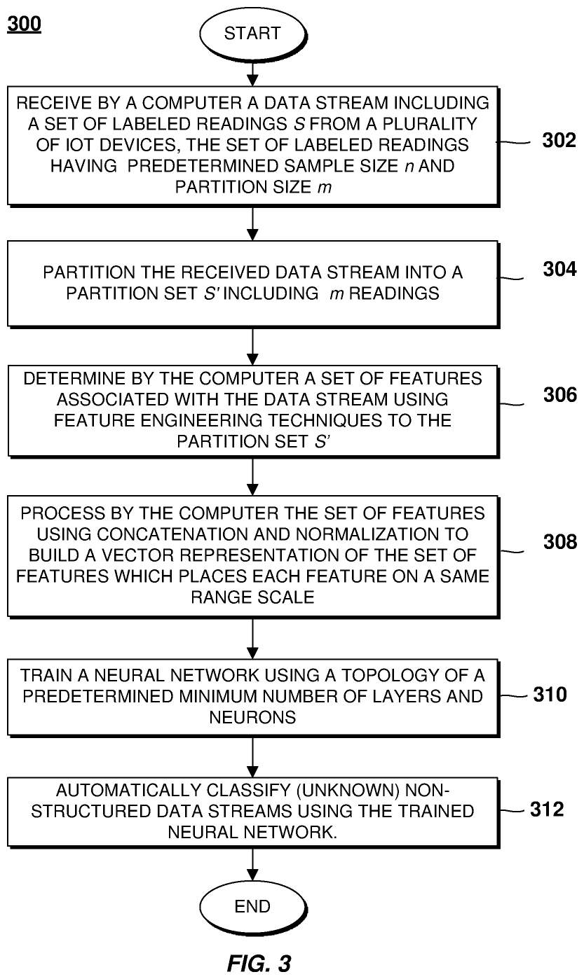

Referring now to FIG. 3, a flowchart 300 illustrating the steps of a computer-implemented method for classifying non-structured data streams is shown, according to an embodiment of the present disclosure.

The process starts at step 302, in this step a computer, such as the client computer 102 in FIG. 1, receives a data stream from a plurality of IoT devices or sensors that includes a set of labeled readings S with a predetermined sample size n and a predetermined partition size m. In this step, the received data stream is a historically classified data stream including a measurement type. The historically classified data stream allows for training a neural network for non-structured data streams classification, as will be described in detail below. The process continues at step 304 in which the computer, via the data stream classification program 108 (FIG. 1), partitions the received data stream into a partition set S′ including m readings determined by the predefined partition size m.

At step 306, a set of features associated with the data stream is determined, by the computer, using feature engineering techniques to the partition set S′. Specifically, a sequence of feature extraction processes including measurement summarization, histogram generation, and Fourier transform are applied to the partition set S′ at step 306. The measurement summarization is performed by computing metrics representing the m readings defined by the partition size m. These metrics include a mean, a standard deviation, a mode, and a median calculated using the predetermined sample size n, with m<n. A measurement function s for summarizing the m readings is also determined at step 306, and based on the summary, each reading of the m readings in the partition set S′ are mapped to corresponding vectors v in a new vector space V.

According to an embodiment, each vector v in the new vector space V includes a number of components given by

$$\frac{n}{m} \times s .$$

Based on the number or components of each vector v in the new vector space V, one or more histograms of counts of a number of readings within a (same) range can be generated to determine a probability distribution for a continuous variable r representing a bandwidth for each range. Finally, a Fourier transform is applied by the computer at step 306 to the set of readings S′ using the predetermined sample size n to decompose the set of readings S′ into sinusoid parameters including amplitude, frequency and phase that could generate the set of readings S.

The process continues at step 308 in which the computer processes the determined set of features using concatenation and normalization to build a vector representation of the set of features which places each feature on a same range scale. Then, at step 310, a neural network is trained using a topology of a predetermined minimum number of layers and neurons that includes: 1) an input layer with a number of neurons corresponding to twice the number of components of the vector representation of the set of features, 2) a hidden layer with an arbitrary number of neurons, and 3) an output layer with a number of neurons corresponding to a number of labels in the set of readings S. Finally, at step 312, the trained neural network can be used by the computer to classify non-structured data streams from new data sources (i.e., IoT devices/sensors).

Embodiments of the present disclosure provide a method, system and computer program product to, among other things, train a neural network for classification of non-structured data streams using a simple neural network topology including a minimum number of layers and neurons selected based on a set of features associated with the data stream determined using feature engineering and machine learning techniques. The simpler topology allows the neural network to be trained faster and be easier to parameterize using the generated vectors, which makes the present embodiments highly scalable and capable of classifying different types of IoT sensors using considerably small data streams. Additionally, the proposed embodiments can gather non-structured data from IoT devices regardless of whether the data sources are known or unknown, by using historical classified data streams and a measurement type.

Referring now to FIG. 4, a block diagram of components of client computer 102 and server computer 114 of networked computer environment 100 of FIG. 1 is shown, according to an embodiment of the present disclosure. It should be appreciated that FIG. 4 provides only an illustration of one implementation and does not imply any limitations regarding the environments in which different embodiments may be implemented. Many modifications to the depicted environment may be made.

Client computer 102 and server computer 114 may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411 are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Client computer 102 and server computer 114 may also include a R/W drive or interface 414 to read from and write to one or more portable computer readable storage media 426. Application programs 411 on client computer 102 and server computer 114 may be stored on one or more of the portable computer readable storage media 426, read via the respective R/W drive or interface 414 and loaded into the respective computer readable storage media 408.

Client computer 102 and server computer 114 may also include a network adapter or interface 416, such as a TCP/IP adapter card or wireless communication adapter (such as a 4G wireless communication adapter using OFDMA technology) for connection to a network 428. Application programs 411 on client computer 102 and server computer 114 may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

Client computer 102 and server computer 114 may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may include hardware and software (stored on computer readable storage media 408 and/or ROM 406).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

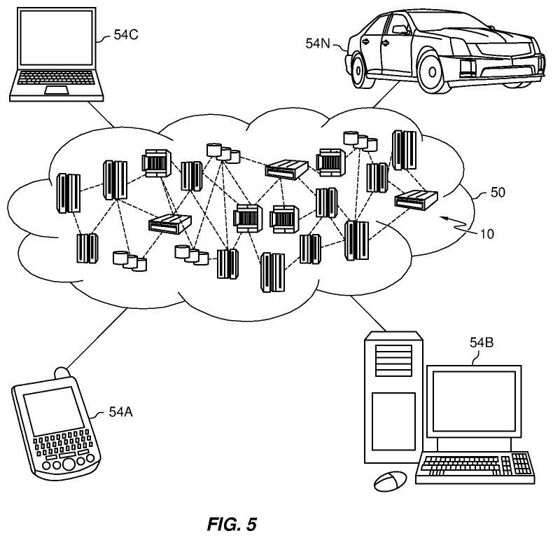

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

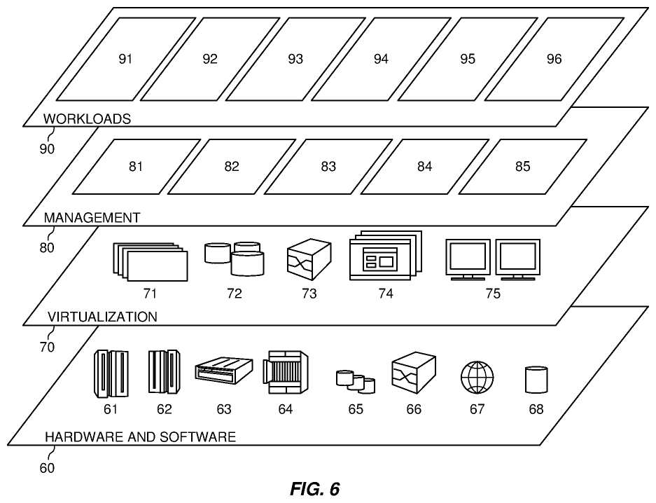

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and system for computer automated classification of non-structured data streams 96.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for classifying non-structured data streams, comprising:
receiving, by one or more processors, from a plurality of Internet of Things (IoT) devices a data stream comprising a set of labeled readings S with a predetermined sample size n and a predetermined partition size m;
in response to receiving the data stream, partitioning, by the one or more processors, the received data stream into a partition set S′ comprising m readings;
determining, by the one or more processors, a set of features associated with the data stream by applying feature engineering techniques to the partition set S′;
processing, by the one or more processors, the set of features using concatenation and normalization to build a vector representation of the set of features to place each feature on a same range scale;
training, by the one or more processors, a neural network using a topology of a predetermined minimum number of layers and neurons selected based on the set of features; and
classifying, by the one or more processors, non-structured data streams using the trained neural network.

2. The method of claim 1, wherein determining the set of features associated with the data stream by applying feature engineering techniques to the partition set S′ further comprises:
applying, by the one or more processors, to the partition set S′ a sequence of feature extraction processes comprising measurement summarization, histogram generation, and a Fourier transform.

3. The method of claim 2, wherein the measurement summarization further comprises:
computing, by the one or more processors, metrics representing the in readings defined by the partition size m, the metrics comprising mean, standard deviation, mode, and median calculated using the predetermined sample size n, wherein m<n.

4. The method of claim 3, further comprising:
determining, by the one or more processors, a measurement function s for summarizing the m readings; and
based on the summary, mapping, by the one or more processors, each of the m readings in the partition set S′ to corresponding vectors v in a new vector space V.

5. The method of claim 4, wherein each vector v in the new vector space V comprises a number of components given by
$$\frac{n}{m} \times s .$$

6. The method of claim 5 further comprising:
based on the number of components of each vector v in the new vector space V, generating, by the one or more processors, a histogram of counts of a number of readings within a range; and
based on the generated histogram, determining, by the one or more processors, a probability distribution for a continuous variable r representing a bandwidth for each range.

7. The method of claim 1, further comprising:
applying, by the one or more processors, a Fourier transform to the set of readings S′ using the predetermined sample size n to decompose the set of readings S′ into sinusoid parameters including amplitude, frequency and phase that can generate the set of readings S.

8. The method of claim 5, wherein the topology used to train the neural network comprises:
an input layer comprising a number of neurons corresponding to twice the number of components of the vector representation of the set of features;
a hidden layer comprising an arbitrary number of neurons; and
an output layer comprising a number of neurons corresponding to a number of labels in the set of readings S.

9. A computer system for classifying non-structured data streams, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
receiving, by the one or more processors, from a plurality of Internet of Things (IoT) devices a data stream comprising a set of labeled readings S with a predetermined sample size n and a predetermined partition size m;
in response to receiving the data stream, partitioning, by the one or more processors, the received data stream into a partition set S′ comprising m readings;
determining, by the one or more processors, a set of features associated with the data stream by applying feature engineering techniques to the partition set S′;
processing, by the one or more processors, the set of features using concatenation and normalization to build a vector representation of the set of features to place each feature on a same range scale;
training, by the one or more processors, a neural network using a topology of a predetermined minimum number of layers and neurons selected based on the set of features; and
classifying, by the one or more processors, non-structured data streams using the trained neural network.

10. The computer system of claim 9, wherein determining the set of features associated with the data stream by applying feature engineering techniques to the partition set S′ further comprises:
applying, by the one or more processors, to the partition set S′ a sequence of feature extraction processes comprising measurement summarization, histogram generation, and a Fourier transform.

11. The computer system of claim 10, wherein the measurement summarization further comprises:
computing, by the one or more processors, metrics representing the in readings defined by the partition size m, the metrics comprising mean, standard deviation, mode, and median calculated using the predetermined sample size n, wherein m<n.

12. The computer system of claim 11, further comprising:
determining, by the one or more processors, a measurement function s for summarizing the m readings; and
based on the summary, mapping, by the one or more processors, each of the m readings in the partition set S′ to corresponding vectors v in a new vector space V.

13. The computer system of claim 12, wherein each vector v in the new vector space V comprises a number of components given by
$$\frac{n}{m} \times s .$$

14. The computer system of claim 13 further comprising:
based on the number of components of each vector v in the new vector space V, generating, by the one or more processors, a histogram of counts of a number of readings within a range; and
based on the generated histogram, determining, by the one or more processors, a probability distribution for a continuous variable r representing a bandwidth for each range.

15. The computer system of claim 9, further comprising:
applying, by the one or more processors, a Fourier transform to the set of readings S′ using the predetermined sample size n to decompose the set of readings S′ into sinusoid parameters including amplitude, frequency and phase that can generate the set of readings S.

16. The computer system of claim 13, wherein the topology used to train the neural network comprises:
an input layer comprising a number of neurons corresponding to twice the number of components of the vector representation of the set of features;
a hidden layer comprising an arbitrary number of neurons; and
an output layer comprising a number of neurons corresponding to a number of labels in the set of readings S.

17. A computer program product for classifying non-structured data streams, comprising:
one or more computer readable storage media, and program instructions collectively stored on the one or more computer readable storage media, the program instructions comprising:
program instructions to receive, by one or more processors, from a plurality of Internet of Things (IoT) devices a data stream comprising a set of labeled readings S with a predetermined sample size n and a predetermined partition size m;
in response to receiving the data stream, program instructions to partition, by the one or more processors, the received data stream into a partition set S′ comprising m readings;
program instructions to determine, by the one or more processors, a set of features associated with the data stream by applying feature engineering techniques to the partition set S′;
program instructions to process, by the one or more processors, the set of features using concatenation and normalization to build a vector representation of the set of features to place each feature on a same range scale;
program instructions to train, by the one or more processors, a neural network using a topology of a predetermined minimum number of layers and neurons selected based on the set of features; and
program instructions to classify, by the one or more processors, non-structured data streams using the trained neural network.

18. The computer program product of claim 17, wherein the program instructions to determine the set of features associated with the data stream by applying feature engineering techniques to the partition set S′ further comprises:
program instructions to apply, by the one or more processors, to the partition set S′ a sequence of feature extraction processes comprising measurement summarization, histogram generation, and a Fourier transform.

19. The computer program product of claim 18, wherein the measurement summarization further comprises:
program instructions to compute, by the one or more processors, metrics representing the m readings defined by the partition size m, the metrics comprising mean, standard deviation, mode, and median calculated using the predetermined sample size n, wherein m<n.

20. The computer program product of claim 19, further comprising:
program instructions to determine, by the one or more processors, a measurement function s for summarizing the m readings; and
based on the summary, program instructions to map, by the one or more processors, each of the m readings in the partition set S′ to corresponding vectors v in a new vector space V.

21. The computer program product of claim 20, wherein each vector v in the new vector space V comprises a number of components given by
$$\frac{n}{m} \times s .$$

22. The computer program product of claim 21 further comprising:
based on the number of components of each vector v in the new vector space V, program instructions to generate, by the one or more processors, a histogram of counts of a number of readings within a range; and
based on the generated histogram, program instructions to determine, by the one or more processors, a probability distribution for a continuous variable r representing a bandwidth for each range.

23. The computer program product of claim 17, further comprising:
program instructions to apply, by the one or more processors, a Fourier transform to the set of readings S′ using the predetermined sample size n to decompose the set of readings S′ into sinusoid parameters including amplitude, frequency and phase that can generate the set of readings S.

24. The computer program product of claim 21, wherein the topology used to train the neural network comprises:
an input layer comprising a number of neurons corresponding to twice the number of components of the vector representation of the set of features;
a hidden layer comprising an arbitrary number of neurons; and
an output layer comprising a number of neurons corresponding to a number of labels in the set of readings S.
